(19) United States
(12) Patent Application Publication
(10) Pub. No.: US 2018/0065792 A1
(43) Pub. Date: Mar. 8, 2018

(54) Tool Holder

(71) Applicant: Chao-Ming Chen, Taichung City 412 (TW)

(72) Inventor: Chao-Ming Chen, Taichung City 412 (TW)

(21) Appl. No.: 15/259,083

(22) Filed: Sep. 8, 2016

(51) Int. Cl. B65D 79/02; B25H 3/00; B65D 73/00

(52) U.S. Cl. CPC B65D 79/02; B65D 73/0064; B25H 3/003

(57) ABSTRACT

A tool holder contains: a connector and a fixer, the connector includes at least one body, and each of the at least one body has a first side plate, a second side plate, and a connection plate. The first side plate has a first fitting portion, and the second side plate has a second fitting portion, wherein the first fitting portion and the second fitting portion define a square fitting zone, and the first side plate further has a first locking projection, wherein between the first fitting portion and the second fitting portion is defined a cavity so that the first fitting portion and the second fitting portion deform inwardly, and the first locking projection retract into the fitting zone. The fixer is housed in the cavity of the connector so as to limit an inward deformation of the first fitting portion and the second fitting portion.

### FIELD OF THE INVENTION

The present invention relates to a tool holder which has anti-theft effect and removes or fits a tool easily.

### BACKGROUND OF THE INVENTION

Socket sets of various sizes are mounted on a tool holder for display and storage.

Referring to FIGS. 1-2, a conventional tool holder 20 contains a plurality of bodies 21 and a fixing mount 22. Each body 21 has a fitting portion 211 extending upwardly from a top thereof and has a notch 212 defined on one side of the fitting portion 211 so as to accommodate a spring 213 and a steel ball 214, such that the spring 213 pushes the steel ball 214 to extend out of the one side of the fitting portion 211. Said each body 21 further has a slidable block 215 arranged on a bottom thereof, and the fixing mount 22 has an accommodation groove 221 defined thereon so as to house the slidable block 215 of said each body 21. A fitting orifice 231 of each of multiple sockets 23 is fitted with the fitting portion 211 of said each body 21, and the steel ball 214 retains with a recess 232 of the fitting orifice 231 of the socket 23, thus fitting the socket 23 with said each body 21.

However, as displaying the tool holder 20, said each socket 23 is removed from the fitting portion of said each body 21 easily by a thief. Furthermore, after purchasing the tool holder 20, the steel ball 214 is pushed by the spring 213, so it is inconvenient to remove said each socket 23 from said each body 21.

The present invention has arisen to mitigate and/or obviate the afore-described disadvantages.

### SUMMARY OF THE INVENTION

The primary objective of the present invention is to provide a tool holder which has anti-theft effect as displaying the tool holder.

Further objective of the present invention is to provide a tool holder in which the fixer is cut after purchasing the tool holder so that the first fitting portion of the first side plate and the second fitting portion of the second side plate deform inwardly, and the first locking projection and the second locking projection retract in the fitting zone defined by the first fitting portion and the second fitting portion so as to remove from the tool, wherein the two diagonal corners of the tool correspond to the first locking projection so as to remove or fix the tool easily.

Another objective of the present invention is to provide a tool holder in which in which the fixer is cut after purchasing the tool holder so that the first fitting portion of the first side plate and the second fitting portion of the second side plate deform inwardly, and the first locking projection retracts in the fitting zone defined by the first fitting portion and the second fitting portion so as to remove from the tool, wherein the two diagonal corners of the tool correspond to the first locking projection so that when removing or fixing the tool, the first locking projection is not scratched, thus prolonging service life of the first locking projection.

To obtain above objectives, a tool holder provided by the present invention contains: a connector and a fixer.

The connector includes at least one body, and each of the at least one body has a first side plate, a second side plate, and a connection plate connecting with a first end of the first side plate and a first end of the second side plate. The first side plate has a first fitting portion extending upwardly from a second end of the first side plate, and the second side plate has a second fitting portion extending upwardly from a second end of the second side plate, wherein the first fitting portion and the second fitting portion define a square fitting zone, and the first side plate further has a first locking projection arranged on the first fitting portion thereof and extending out of the fitting zone, wherein between the first fitting portion and the second fitting portion is defined a cavity so that the first fitting portion and the second fitting portion deform inwardly, and the first locking projection retract into the fitting zone.

The fixer is housed in the cavity of the connector so as to limit an inward deformation of the first fitting portion and the second fitting portion.

### BRIEF DESCRIPTION OF THE DRAWINGS

FIG. 1 is a perspective view of a conventional tool holder.

FIG. 2 is a cross sectional view of the conventional tool holder.

FIG. 3 is a perspective view showing the exploded components of a tool holder according to a first embodiment of the present invention.

FIG. 4 is a cross sectional view showing the assembly of a part of the tool holder according to the first embodiment of the present invention.

FIG. 5 is a cross sectional view showing the operation of a part of the tool holder according to the first embodiment of the present invention.

FIG. 6 is a cross sectional view taken the line A-A of FIG. 5.

FIGS. 7 to 15 are cross sectional views respectively showing the operation of the tool holder according to the first embodiment of the present invention.

FIG. 16 is a perspective view showing the exploded components of a tool holder according to a second embodiment of the present invention.

FIG. 17 is a side plan view showing the assembly of a part of the tool holder according to the second embodiment of the present invention.

FIG. 18 is a cross sectional view taken along the line B-B of FIG. 17.

FIG. 19 is a cross sectional view showing the operation of a part of the tool holder according to the second embodiment of the present invention.

FIG. 20 is a cross sectional view taken along the line C-C of FIG. 19.

FIGS. 21 to 29 are cross sectional views respectively showing the operation of the tool holder according to the second embodiment of the present invention.

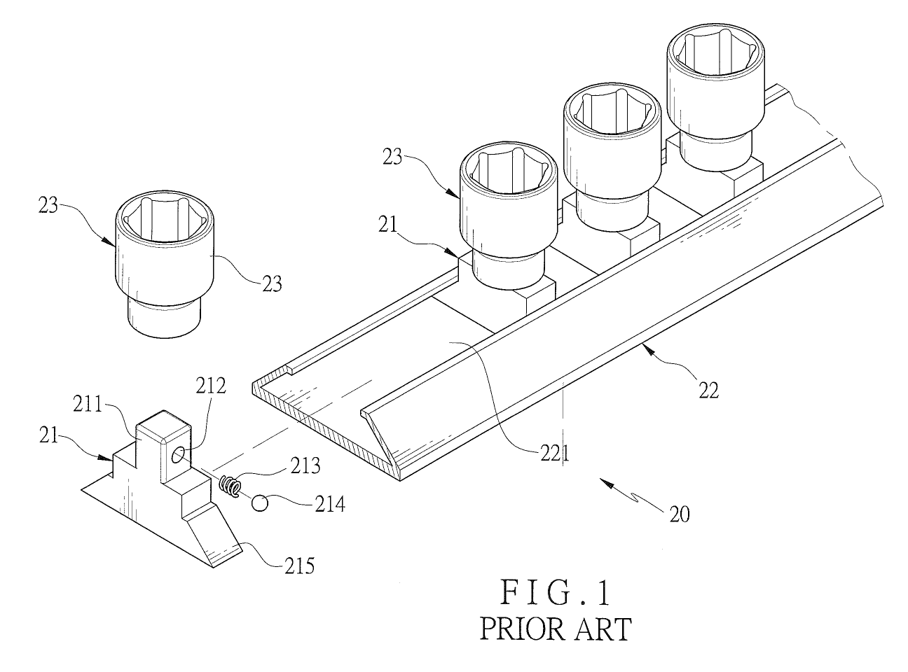

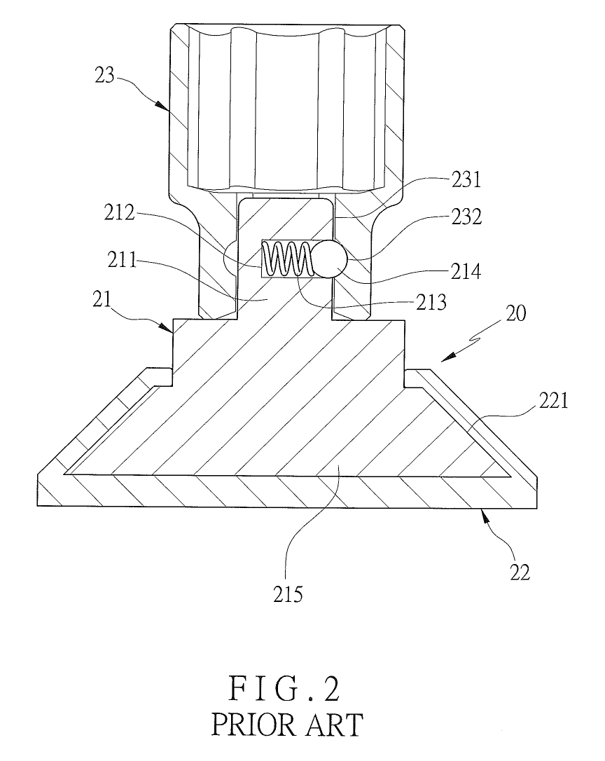

### DETAILED DESCRIPTION OF THE PREFERRED EMBODIMENTS

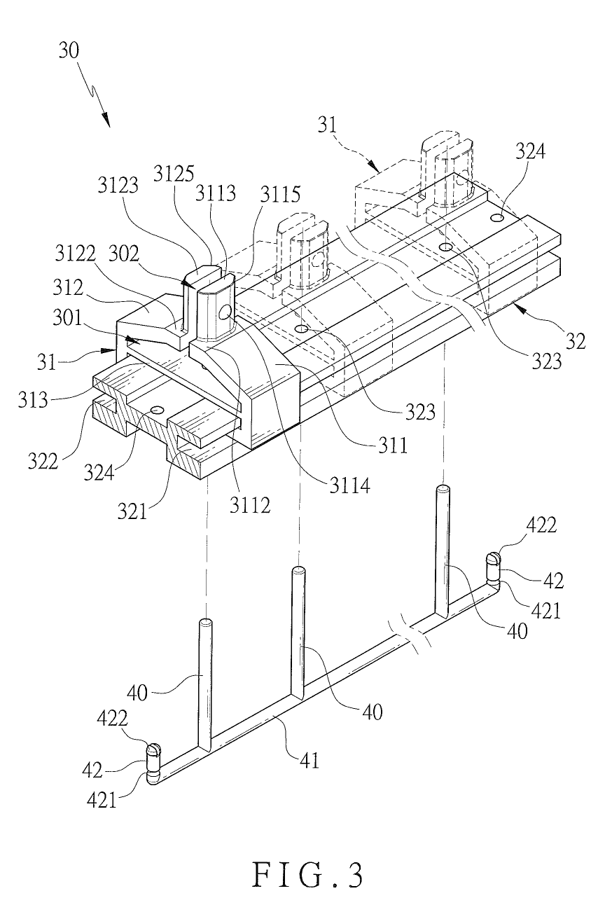

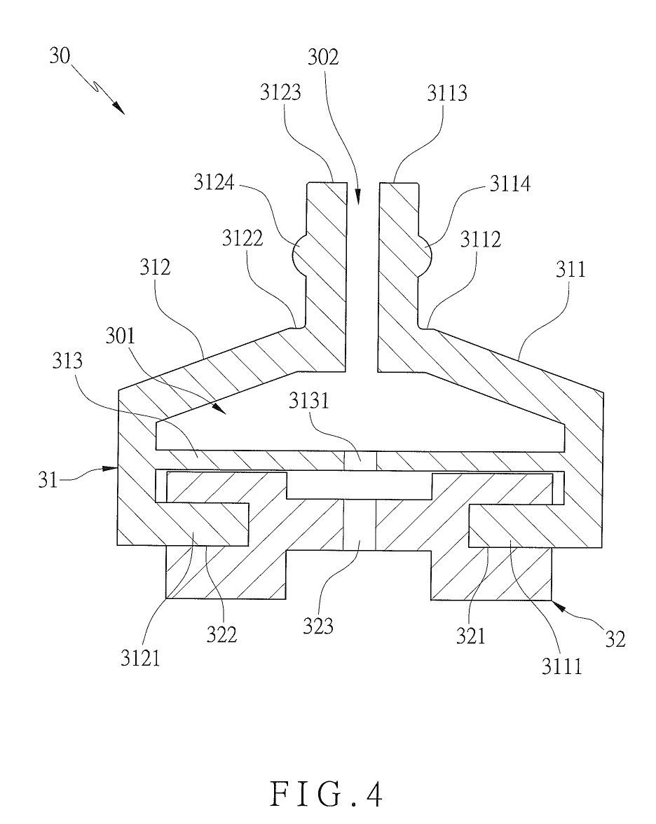

With reference to FIGS. 3 and 4, a tool holder according to a first embodiment of the present invention comprises: a connector 30 and a fixer 40. The connector 30 includes at least one body 31, and each of the at least one body 31 has a first side plate 311, a second side plate 312, and a connection plate 313 connecting with a first end of the first side plate 311 and a first end of the second side plate 312. In this embodiment, the first end of the first side plate 311 and the first end of the second side plate 312 are in connection on a fixing mount 32, wherein the first side plate 311 has a first extension 3111 bending inwardly from the first end thereof, and the second side plate 312 has a second extension 3121 bending inwardly from the first end thereof. The fixing mount 32 has a first accommodation groove 321 defined on a first side thereof so as to fit with the first extension 3111 of the first side plate 311, and the fixing mount 32 has a second accommodation groove 322 defined on a second side thereof so as to fit with the second extension 3121 of the second side plate 312, wherein the fixing mount 32 has a predetermined length so as to fit with a plurality of bodies 31. The fixing mount 32 further has two covering members (not shown) arranged on two ends thereof respectively so as to limit the plurality of bodies 31 on the fixing mount 32. Since the two covering members are a well-known prior art, further remarks are omitted. The first side plate 311 and the second side plate 312 of said each body 31 obliquely extend inward. In this embodiment, the first side plate 311 also has a first stop portion 3112 formed on a second end thereof and has a first fitting portion 3113 extending upwardly from the first stop portion 3112, and the second side plate 312 also has a second stop portion 3122 formed on a second end thereof and has a second fitting portion 3123 extending upwardly from the second stop portion 3122, wherein the first fitting portion 3113 and the second fitting portion 3123 define a square fitting zone for fitting a tool. The first side plate 311 further has a first locking projection 3114 arranged on the first fitting portion 3113 thereof and extending out of the fitting zone defined by the first fitting portion 3113 and the second fitting portion 3123. In this embodiment, the second side plate 312 has a second locking projection 3124 arranged on the second fitting portion 3123 thereof and corresponding to the first locking projection 3114, wherein when the first fitting portion 3113 and the second fitting portion 3123 fit with the tool, the first stop portion 3112 and the second stop portion 3122 limit the tool, and the first locking projection 3114 and the second locking projection 3124 engage the tool. The first fitting portion 3113 has two first tilted faces 3115 defined on two edges of an outer rim thereof respectively, and the second fitting portion 3123 has two second tilted faces 3125 defined on two edges of an outer rim thereof respectively so as to guide the tool to rotate 45 degrees, wherein among the first side plate 311, the second side plate 312, and the connection plate 313 is defined a chamber 301, and between the first fitting portion 3113 and the second fitting portion 3123 is defined a cavity 302, such that the first side plate 311 and the second side plate 312 are forced to drive the first fitting portion 3113 and the second fitting portion 3123 to deform inwardly, and the first locking projection 3114 and the second locking projection 3124 retract into the fitting zone defined by the first fitting portion 3113 and the second fitting portion 3123 so as to release the tool.

The fixer 40 is housed in the cavity 302 of said each body 31 of the connector 30 so as to limit inward deformation of the first fitting portion 3113 of the first side plate 311 and the second first fitting portion 3123 of the second side plate 312, and the first locking projection 3114 of the first fitting portion 3113 and the second locking projection 3124 of the second fitting portion 3123 engage the tool, thus obtaining anti-theft effect of the tool. In this embodiment, the connection plate 313 has a through hole 3131 so as to accommodate the fixer 40, wherein the plurality of bodies 31 are fitted on the fixing mount 32, the fixing mount 32 further has multiple orifices 323, and each orifice 323 is configured to accommodate the fixer 40.

In this embodiment, the fixer 40 includes a horizontal column 41 extending from a bottom end thereof, and the fixer 40 also includes two vertical columns 42 arranged on two edges of the horizontal column 41, wherein each of the two vertical column 42 has a neck 421 formed on a first end thereof and a flexible fastening tab 422 arranged on a second end thereof. The fixing mount 32 has multiple notches 324, and each of the multiple notches 324 accommodates the flexible fastening tab 422 of said each vertical column 42, hence the fixer 40 is mounted in the cavity 302 of the connector 30 so as to limit the inward deformation of the first fitting portion 3113 and the second fitting portion 3123, thus obtaining the anti-theft effect of the tool.

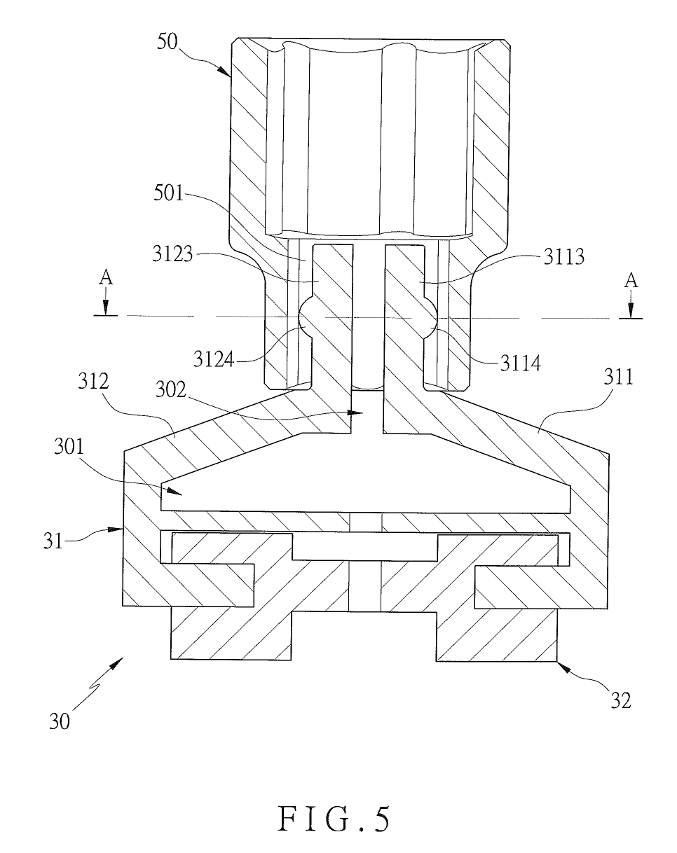

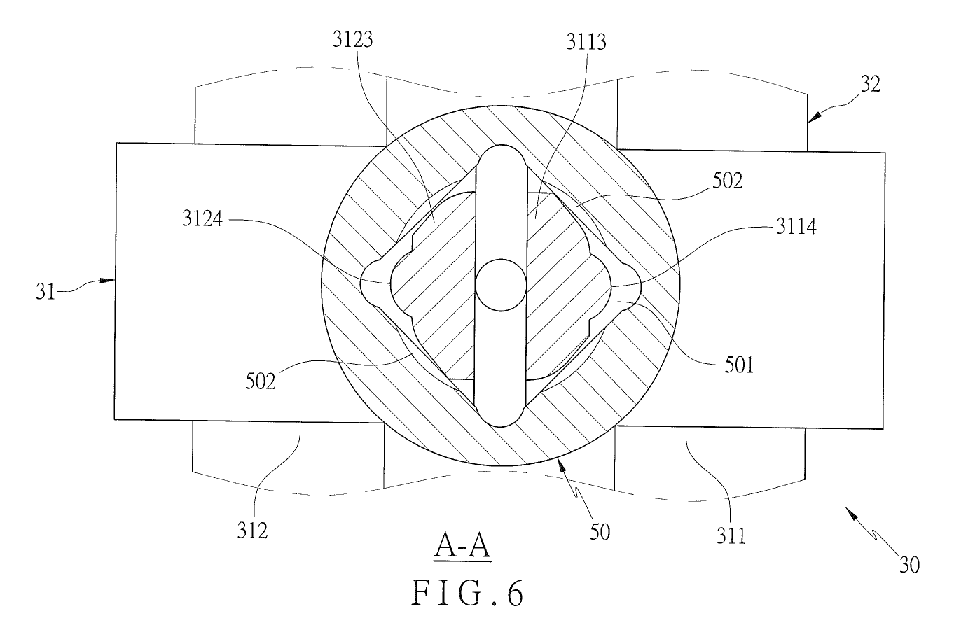

Referring to FIGS. 5 and 6, the tool is a socket or a connection rod. Taking the socket 50 for example, it has a square hole 501 defined on one end thereof so as to fit with the fitting zone defined by the first fitting portion 3113 and the second fitting portion 3123 of said each body 31, and the square hole 501 has four retaining recesses 502 individually arranged on four peripheral walls thereof, wherein each retaining recess 502 retains with the first locking projection 3114 or the second locking projection 3124. Two diagonal corners of the socket 50 correspond to the first locking projection 3114 and the second locking projection 3124, wherein a distance between the two diagonal corners of the socket 50 is more than an extending length of each of the first locking projection 3114 and the second locking projection 3124, so the square hole 501 of the socket 50 fits with the first fitting portion 3113 and the second fitting portion 3123.

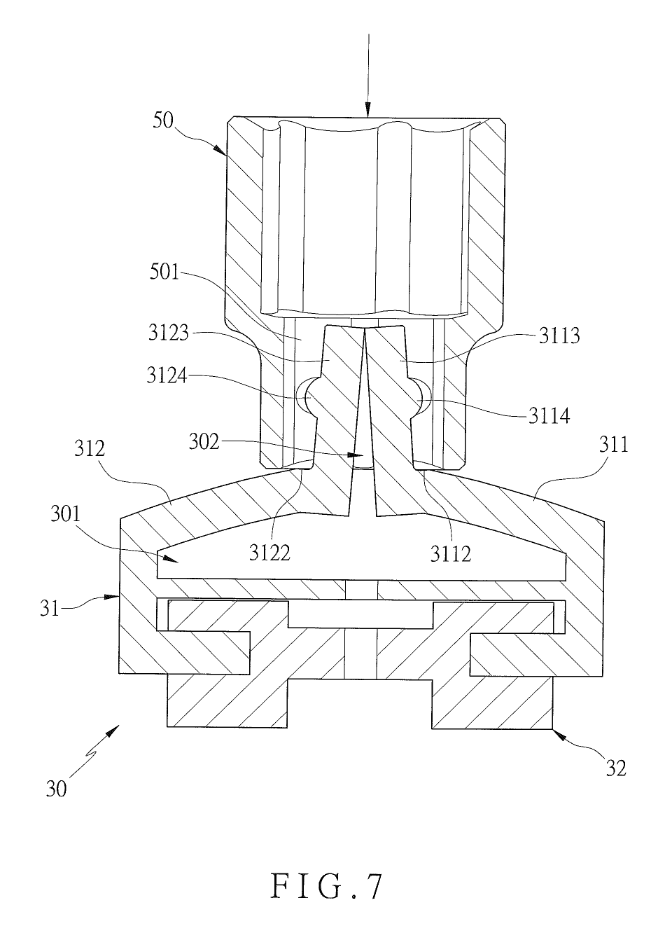

As illustrated in FIG. 7, the socket 50 is pressed to abut against the first stop portion 3112 of the first side plate 311 and the second stop portion 3122 of the second side plate 312, and the first side plate 311 and the second side plate 312 drive the first fitting portion 3113 and the second fitting portion 3123 to deform inwardly, then the first locking projection 3114 and the second locking projection 3124 retract into the fitting zone defined by the first fitting portion 3113 and the second fitting portion 3123.

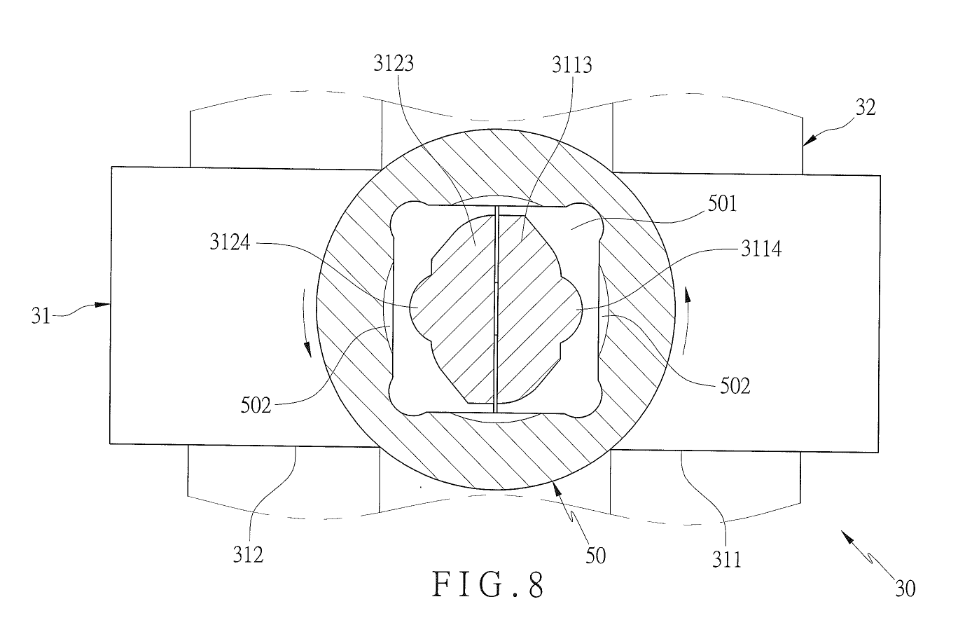

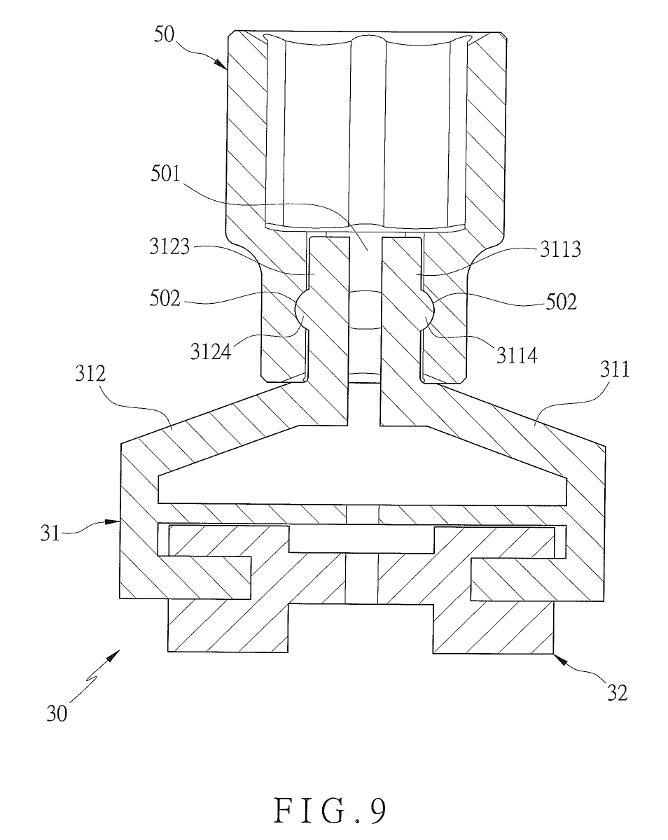

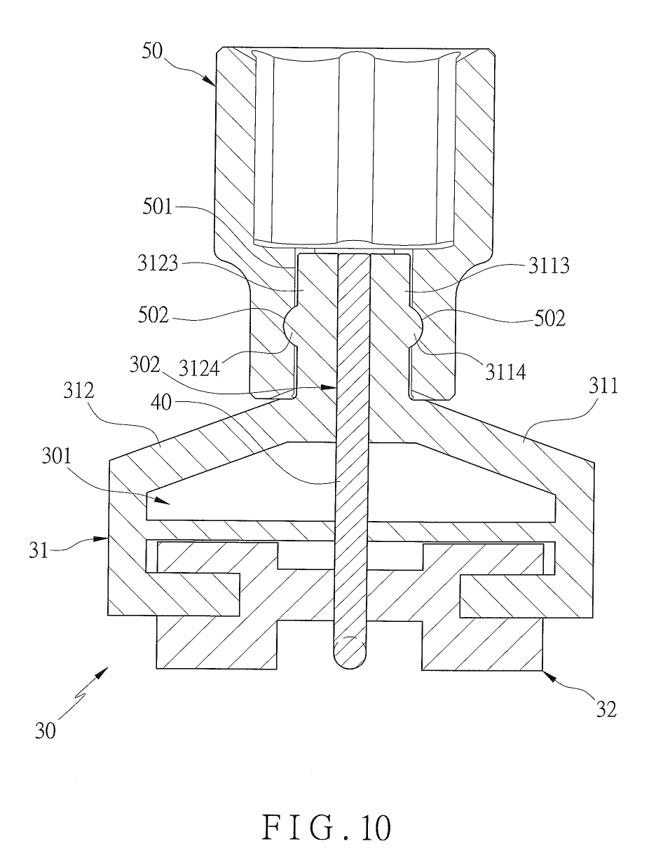

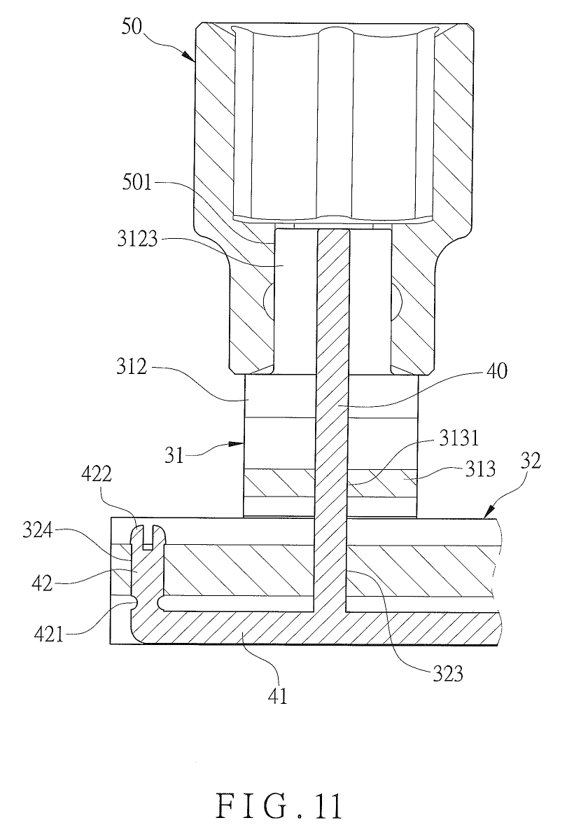

With reference to FIG. 8, the socket 50 is rotated 45 degrees so that two of the four retaining recesses 502 correspond to the first locking projection 3114 and the second locking projection 3124 individually. Referring further to FIG. 9, as stopping pressing the socket 50, the first fitting portion 3113 and the first locking projection 3114 of the first side plate 311 and the second fitting portion 3123 and the second locking projection 3124 of the second side plate 312 return back to their original positions respectively, hence the first locking projection 3114 and the second locking projection 3124 individually retain with the two retaining recesses 502, thus fitting the socket 50 with the connector 30. Referring further to FIGS. 10 and 11, the fixer 40 is inserted into the multiple orifices 323 of the fixing mount 32 and the through hole 3131 of the connection plate 313, wherein said each notch 324 of the fixing mount 32 accommodates the flexible fastening tab 422 of said each vertical column 42 so that the fixer 40 is fixed in the cavity 302 of the connector 30, and the fixer 40 limits the inward deformation of the first fitting portion 3113 of the first side plate 311 and the second first fitting portion 3123 of the second side plate 312, wherein the first locking projection 3114 of the first fitting portion 3113 and the second locking projection 3124 of the second fitting portion 3123 retain the two retaining recesses 502 of the socket 50, hence the socket 50 is not removed from the first fitting portion 3113 of the first side plate 311 and the second first fitting portion 3123 of the second side plate 312 so as to obtain anti-theft effect.

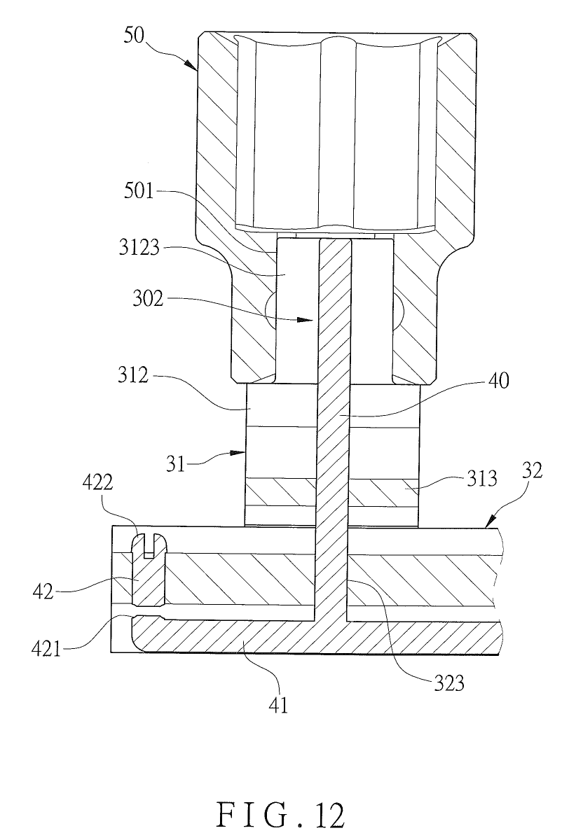

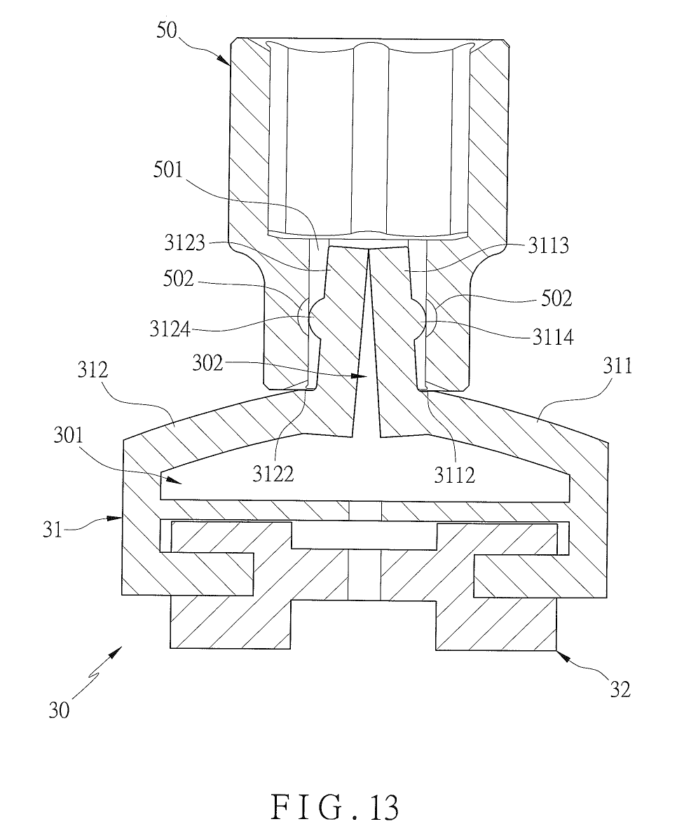

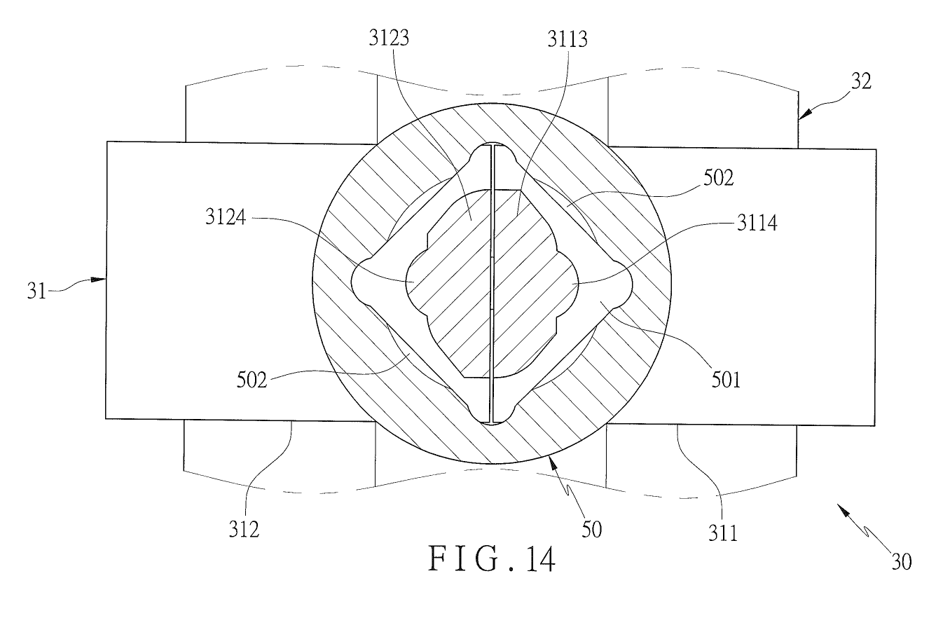

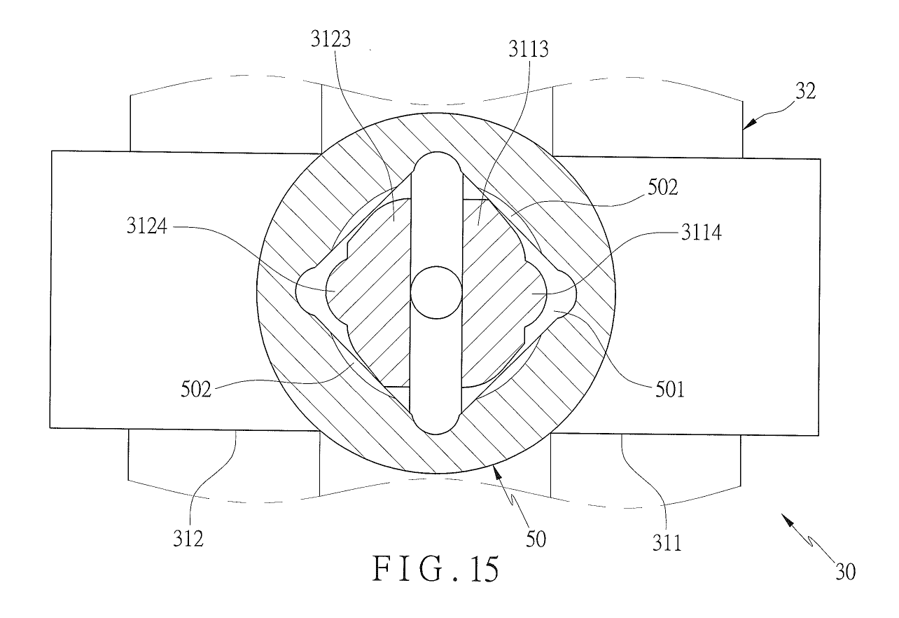

As shown in FIGS. 12 and 13, the neck 421 of said each vertical column 42 is cut so that the fixer 40 is removed from the cavity 302 of said each body 31, and the inward deformation of the first fitting portion 3113 of the first side plate 311 and the second fitting portion 3123 of the second side plate 312 is released. Thereafter, the socket 50 is pressed to abut against the first stop portion 3112 of the first side plate 311 and the second stop portion 3122 of the second side plate 312, the first side plate 311 and the second side plate 312 drive the first fitting portion 3113 and the second fitting portion 3123 to deform inwardly, and the first locking projection 3114 and the second locking projection 3124 retract into the fitting zone defined by the first fitting portion 3113 and the second fitting portion 3123, hence the first locking projection 3114 and the second locking projection 3124 remove from the two retaining recesses 502 of the socket 50 individually. With reference to FIG. 14, the first locking projection 3114 and the second locking projection 3124 retract into the fitting zone defined by the first fitting portion 3113 and the second fitting portion 3123, so the socket 50 is rotated 45 degrees easily. Preferably, the first fitting portion 3113 has the two first tilted faces 3115, and the second fitting portion 3123 has the two second tilted faces 3125, so the socket 50 is rotated 45 degrees so that the two diagonal corners of the square hole 501 of the socket 50 are revolved to correspond to the first locking projection 3114 and the second locking projection 3124 respectively. Referring to FIG. 15, as stopping pressing the socket 50, the first fitting portion 3113 and the first locking projection 3114 of the first side plate 311 and the second fitting portion 3123 and the second locking projection 3124 of the second side plate 312 return back to their original positions individually. Due to the first locking projection 3114 and the second locking projection 3124 correspond to the two diagonal corners of the square hole 501 of the socket 50, and the distance between the two diagonal corners of the square hole 501 is more than the extending distance of each of the first locking projection 3114 and the second locking projection 3124, the first locking projection 3114 and the second locking projection 3124 do not retain with the socket 50, hence the socket 50 is removed easily.

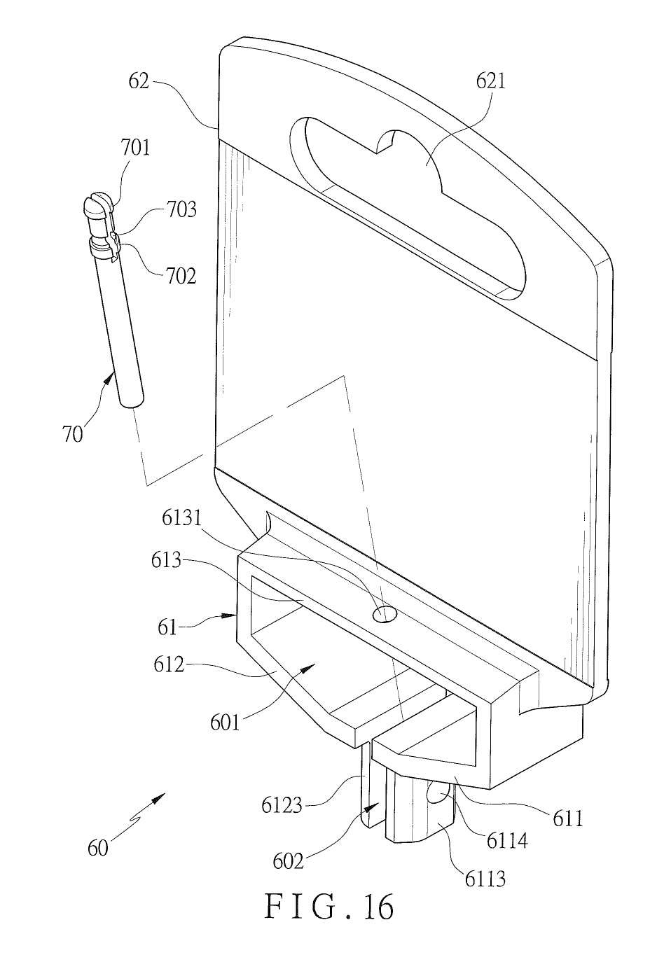

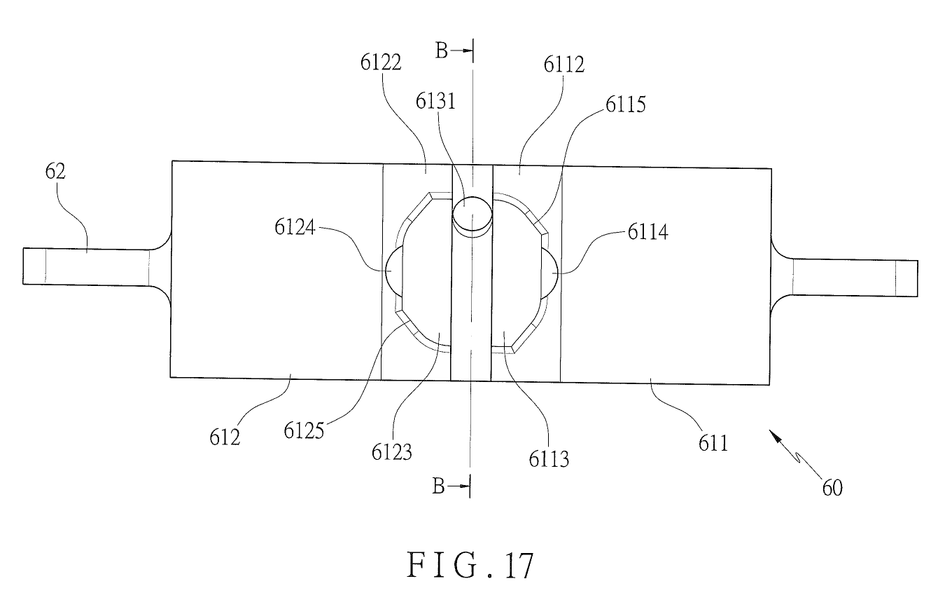

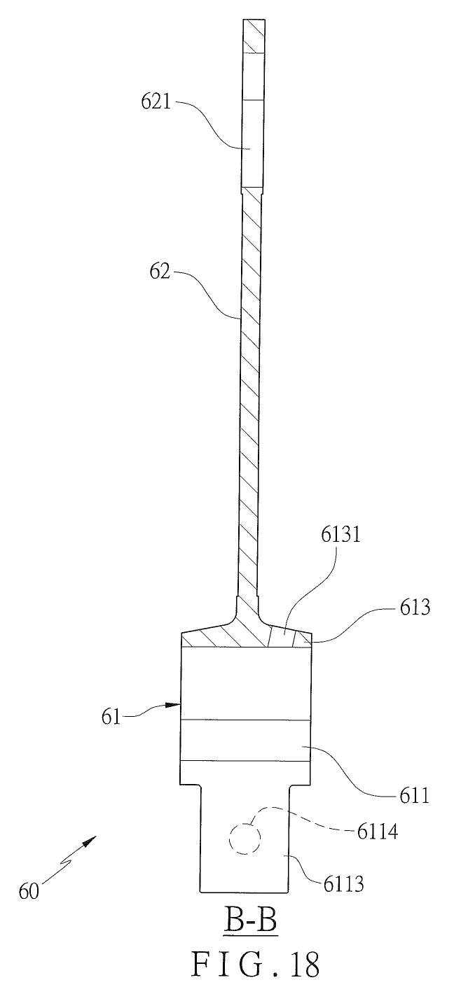

With reference to FIGS. 16 to 18, a tool holder according to a second embodiment of the present invention comprises: a connector 60 and a fixer 70.

The connector 60 includes at least one body 61, and each of the at least one body 61 has a first side plate 611, a second side plate 612, and a connection plate 613 connecting with a first end of the first side plate 611 and a first end of the second side plate 612. In this embodiment, the first end of the first side plate 611 and the first end of the second side plate 612 are integrally connected with a fixing mount 62, and the fixing mount 62 has a hanging aperture 621 defined away from the connection plate 613. The first side plate 611 and the second side plate 612 of said each body 61 obliquely extend inward, wherein the first side plate 611 also has a first stop portion 6112 formed on a second end thereof and has a first fitting portion 6113 extending upwardly from the first stop portion 6112, and the second side plate 612 also has a second stop portion 6122 formed on a second end thereof and has a second fitting portion 6123 extending upwardly from the second stop portion 6122, wherein the first fitting portion 6113 and the second fitting portion 6123 define a square fitting zone for fitting a tool. The first side plate 611 further has a first locking projection 6114 arranged on the first fitting portion 6113 thereof and extending out of the fitting zone defined by the first fitting portion 6113 and the second fitting portion 6123. In this embodiment, the second side plate 612 has a second locking projection 6124 arranged on the second fitting portion 6123 thereof and corresponding to the first locking projection 6114, wherein when the first fitting portion 6113 and the second fitting portion 6123 fit with the tool, the first stop portion 6112 and the second stop portion 6122 limit the tool, and the first locking projection 6114 and the second locking projection 6124 engage the tool.

The first fitting portion 6113 has two first tilted faces 6115 defined on two edges of an outer rim thereof respectively, and the second fitting portion 6123 has two second tilted faces 6125 defined on two edges of an outer rim thereof respectively so as to guide the tool to rotate 45 degrees, wherein among the first side plate 611, the second side plate 612, and the connection plate 613 is defined a chamber 601, and between the first fitting portion 6113 and the second fitting portion 6123 is defined a cavity 602 so that the first side plate 611 and the second side plate 612 are forced to drive the first fitting portion 6113 and the second fitting portion 6123 to deform inwardly, and the first locking projection 6114 and the second locking projection 6124 retract into the fitting zone defined by the first fitting portion 6113 and the second fitting portion 6123, thus releasing the tool.

The fixer 70 is housed in the cavity 602 of the connector 60 so as to limit the inward deformation of the first fitting portion 6113 of the first side plate 611 and the second first fitting portion 6123 of the second side plate 612, and the first locking projection 6114 and the second locking projection 6124 engage the tool, thus obtaining anti-theft effect of the tool.

In this embodiment, the connection plate 613 has a through hole 6131 tilting toward the first fitting portion 6113 and the second fitting portion 6123 so as to accommodate the fixer 70, wherein the fixer 70 includes a first flexible fastening tab 701 and a second flexible fastening tab 702 which form on one end of the fixer 70 adjacent to the hanging aperture 621, and between the first flexible fastening tab 701 and the second flexible fastening tab 702 is defined a neck 703, wherein the first flexible fastening tab 701 and the second flexible fastening tab 702 retain with the through hole 6131 of the connection plate 613 so that the fixer 70 is housed in the cavity 602 of the connector 60, and the inward deformation of the first fitting portion 6113 and the second first fitting portion 6123 is limited by the fixer 70, thus obtaining anti-theft effect.

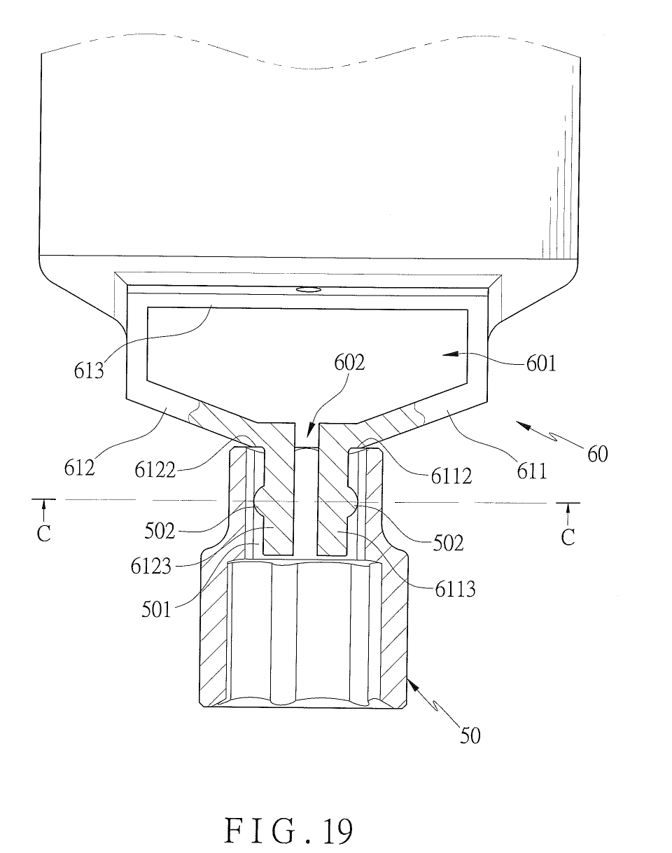

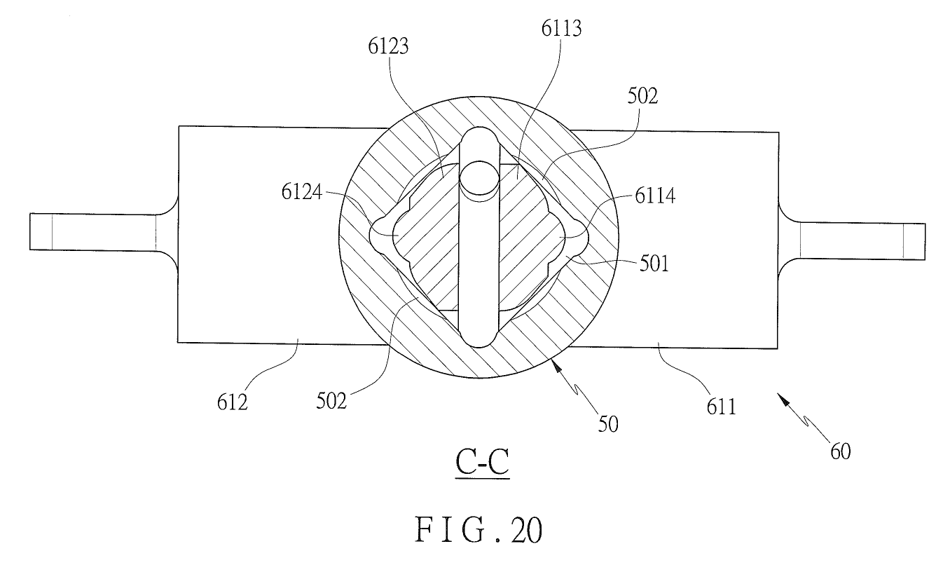

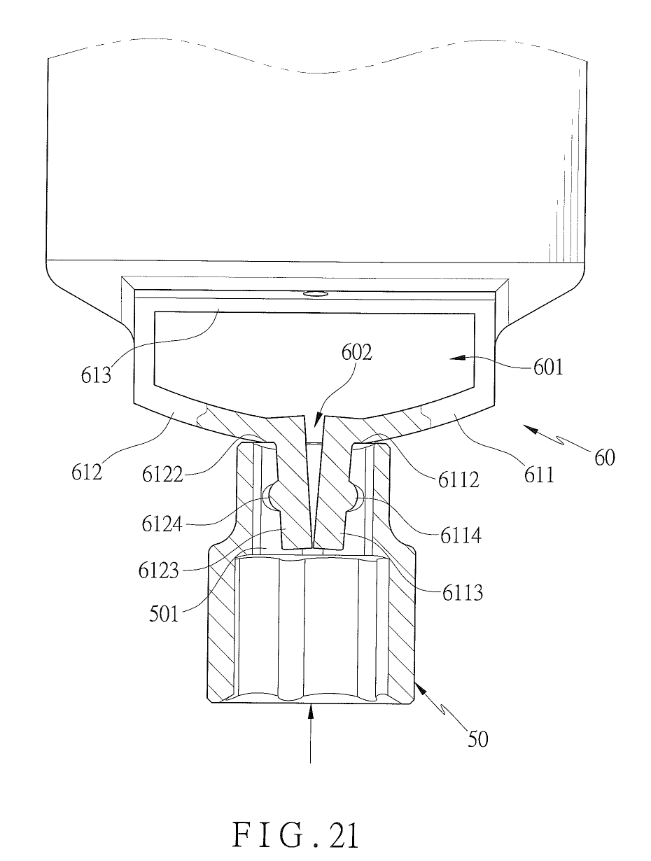

Referring to FIGS. 19 and 20, when two diagonal corners of the square hole 501 of the socket 50 correspond to the first locking projection 6114 and the second locking projection 6124, a distance between the two diagonal corners of the socket 50 is more than an extending length of each of the first locking projection 6114 and the second locking projection 6124, so the square hole 501 of the socket 50 fits with the first fitting portion 6113 and the second fitting portion 6123. Referring to FIG. 21, as stopping pressing the socket 50, the socket 50 abuts against the first stop portion 6112 of the first side plate 611 and the second stop portion 6122 of the second side plate 612 so that the first side plate 611 and the second side plate 612 drive the first fitting portion 6113 and the second fitting portion 6123 to deform inwardly, hence the first locking projection 6114 and the second locking projection 6124 retract into the fitting zone defined by the first fitting portion 6113 and the second fitting portion 6123.

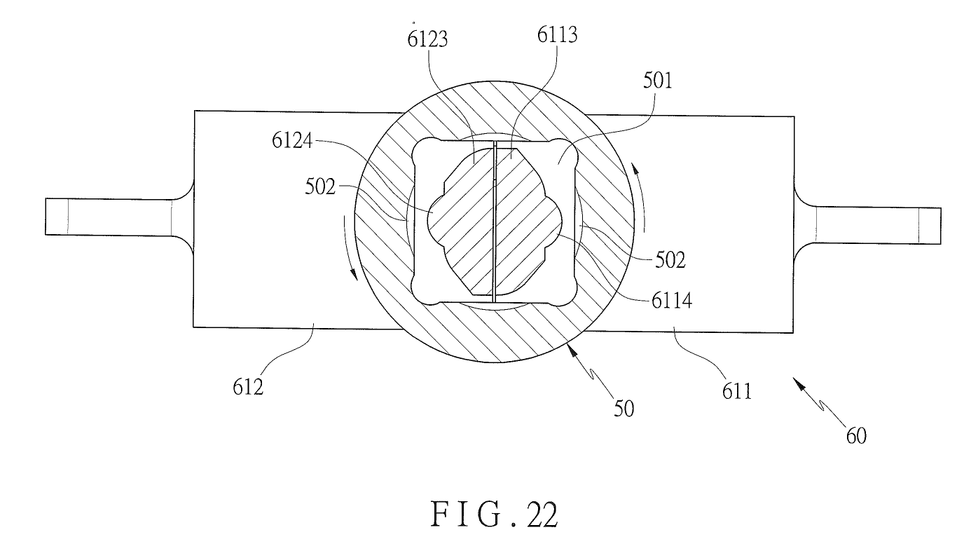

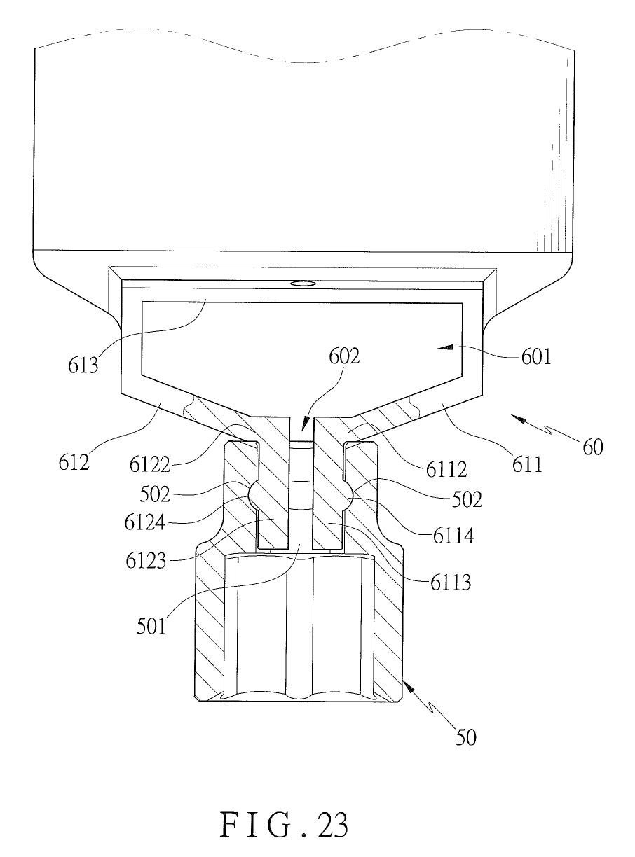

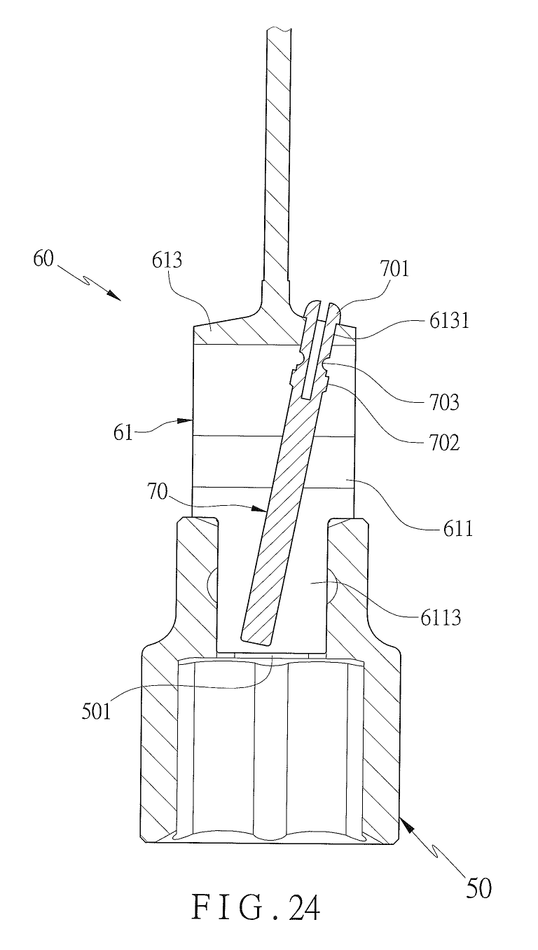

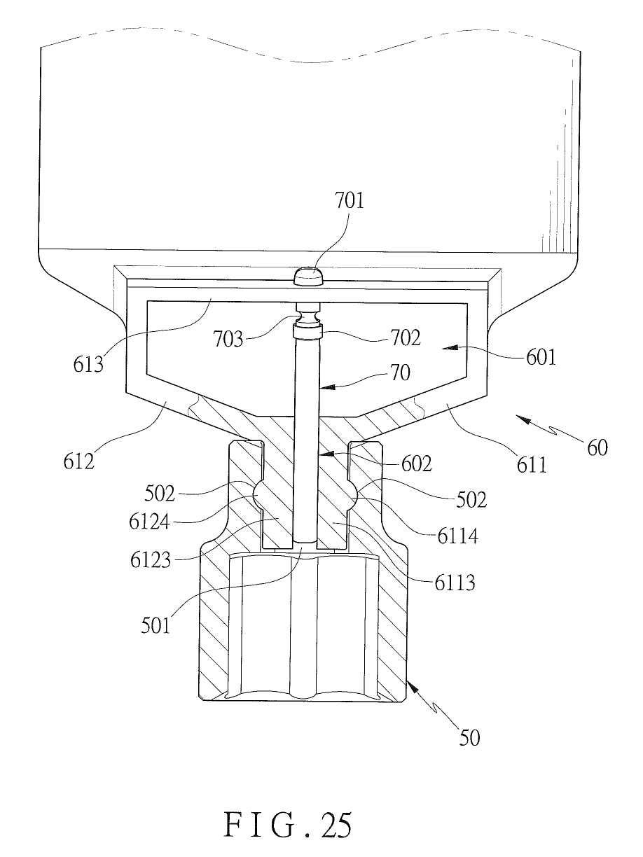

With reference to FIG. 22, the socket 50 is rotated 45 degrees so that two of the four retaining recesses 502 correspond to the first locking projection 6114 and the second locking projection 6124 individually. Referring further to FIG. 23, as stopping pressing the socket 50, the first fitting portion 6113 and the first locking projection 6114 of the first side plate 611 and the second fitting portion 6123 and the second locking projection 6124 of the second side plate 612 return back to their original positions respectively, hence the first locking projection 6114 and the second locking projection 6124 individually retain with the two retaining recesses 502 of the socket 50, thus fitting the socket 50 with the connector 60. Referring further to FIGS. 24 and 25, the fixer 70 is inserted into the through hole 6131 of the connection plate 613, wherein the first flexible fastening tab 701 and the second flexible fastening tab 702 of the fixer 70 retain with the through hole 6131 of the connection plate 613, and the fixer 70 is fixed in the cavity 602 of the connector 60 so that the fixer 70 limits the inward deformation of the first fitting portion 6113 of the first side plate 611 and the second first fitting portion 6123 of the second side plate 612, and the first locking projection 6114 of the first fitting portion 6113 and the second locking projection 6124 of the second fitting portion 6123 retain the two retaining recesses 502 of the socket 50, hence the socket 50 is not removed from the first fitting portion 6113 and the second first fitting portion 6123 so as to obtain anti-theft effect of the socket 50.

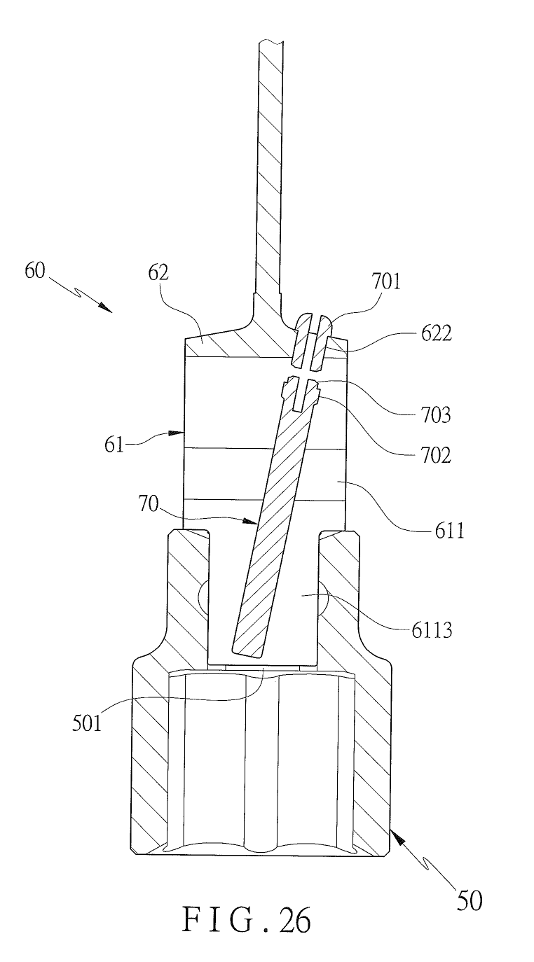

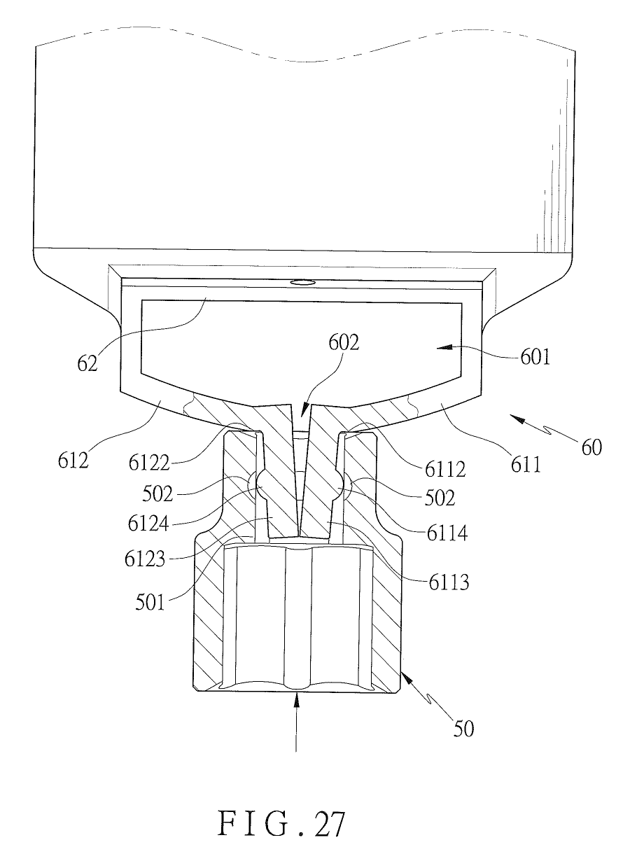

As shown in FIGS. 26 and 27, the neck 703 of the fixer 70 is cut so that the fixer 70 is removed from the cavity 602 of the connector 60, and the inward deformation of the first fitting portion 6113 of the first side plate 611 and the second fitting portion 6123 of the second side plate 612 is released. Thereafter, the socket 50 is pressed to abut against the first stop portion 6112 of the first side plate 611 and the second stop portion 6122 of the second side plate 612, the first side plate 611 and the second side plate 612 drive the first fitting portion 613 and the second fitting portion 6123 to move inwardly, and the first locking projection 6114 and the second locking projection 6124 retract into the fitting zone defined by the first fitting portion 6113 and the second fitting portion 6123, hence the first locking projection 6114 and the second locking projection 6124 remove from the two retaining recesses 502 of the socket 50 individually.

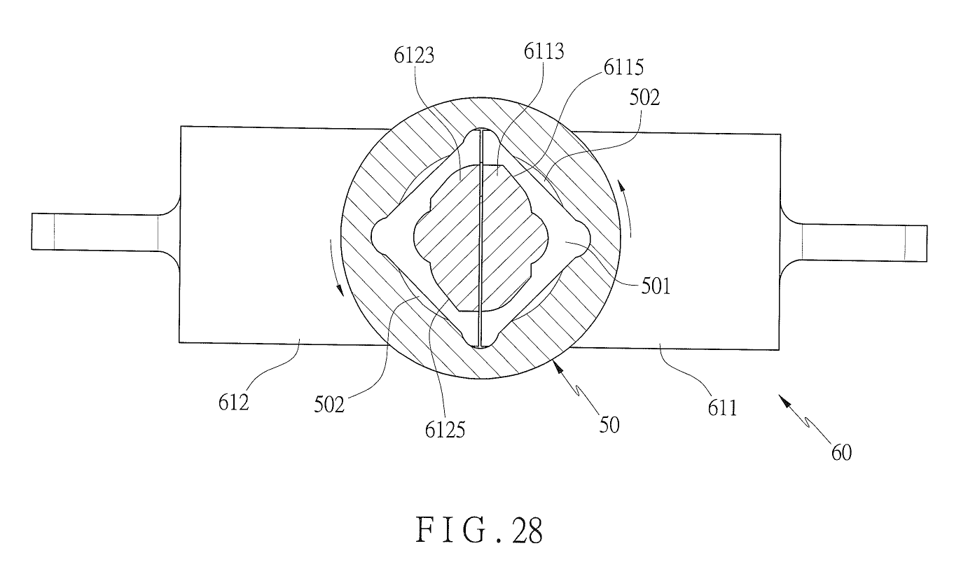

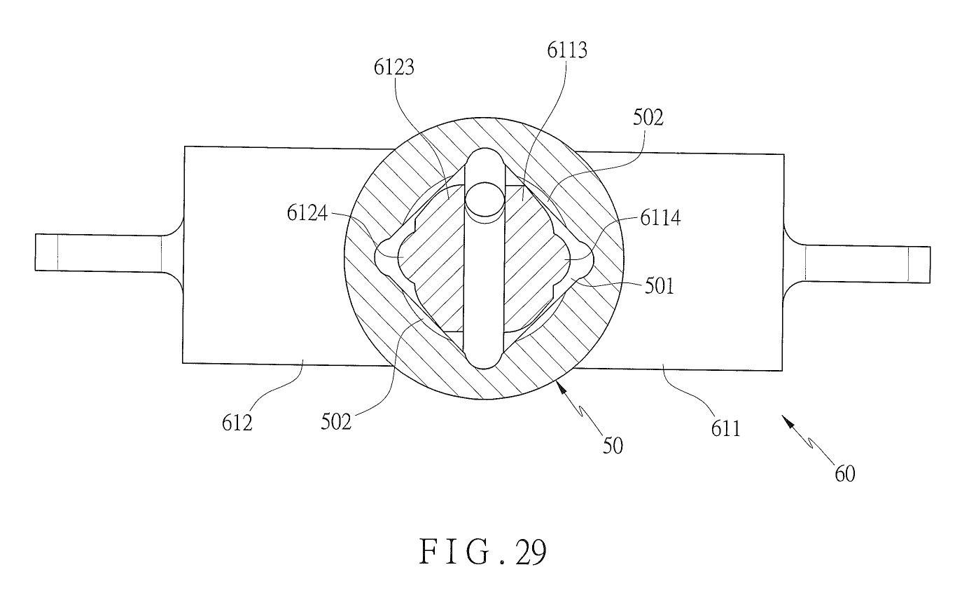

With reference to FIG. 28, the first locking projection 6114 and the second locking projection 6124 retract into the fitting zone defined by the first fitting portion 6113 and the second fitting portion 6123, so the socket 50 is rotated 45 degrees easily. Preferably, the first fitting portion 6113 has the two first tilted faces 6115, and the second fitting portion 6123 has the two second tilted faces 6125, hence the socket 50 is rotated 45 degrees so that the two diagonal corners of the square hole 501 of the socket 50 are revolved to correspond to the first locking projection 6114 and the second locking projection 6124 respectively. Referring to FIG. 29, as stopping pressing the socket 50, the first fitting portion 6113 and the first locking projection 6114 of the first side plate 611 and the second fitting portion 6123 and the second locking projection 6124 of the second side plate 612 return back to their original positions individually. Due to the first locking projection 6114 and the second locking projection 6124 correspond to the two diagonal corners of the square hole 501 of the socket 50, and the distance between the two diagonal corners of the square hole 501 is more than the extending distance of each of the first locking projection 6114 and the second locking projection 6124, the first locking projection 6114 and the second locking projection 6124 do not retain with the socket 50, hence the socket 50 is removed easily.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A tool holder comprising:
a connector including at least one body, and each of the at least one body having a first side plate, a second side plate, and a connection plate connecting with a first end of the first side plate and a first end of the second side plate, the first side plate having a first fitting portion extending upwardly from a second end of the first side plate, and the second side plate having a second fitting portion extending upwardly from a second end of the second side plate, wherein the first fitting portion and the second fitting portion define a fitting zone, and the first side plate further has a first locking projection arranged on the first fitting portion thereof and extending out of the fitting zone, wherein between the first fitting portion and the second fitting portion is defined a cavity so that the first fitting portion and the second fitting portion deform inwardly, and the first locking projection retract into the fitting zone; and
a fixer housed in the cavity of the connector so as to limit an inward deformation of the first fitting portion and the second fitting portion.

2. The tool holder as claimed in claim 1, wherein the first end of the first side plate and the first end of the second side plate are in connection on a fixing mount.

3. The tool holder as claimed in claim 2, wherein the first side plate also has a first extension bending inwardly from the first end thereof, and the second side plate also has a second extension bending inwardly from the first end thereof, the fixing mount has a first accommodation groove defined on a first side thereof so as to fit with the first extension, and the fixing mount has a second accommodation groove defined on a second side thereof so as to fit with the second extension.

4. The tool holder as claimed in claim 2, wherein the connection plate has a through hole so as to accommodate the fixer, and the fixing mount further has multiple orifices, wherein each orifice is configured to accommodate the fixer, the fixer includes a horizontal column extending from a bottom end thereof, and the fixer also includes two vertical columns arranged on two edges of the horizontal column, wherein each of the two vertical column has a neck formed on a first end thereof and has a flexible fastening tab arranged on a second end thereof, the fixing mount has multiple notches, and each of the multiple notches accommodates the flexible fastening tab of said each vertical column.

5. The tool holder as claimed in claim 1, wherein the connection plate has a through hole configured to accommodate the fixer, and the fixer includes a first flexible fastening tab and a second flexible fastening tab which form on one end of the fixer, and between the first flexible fastening tab and the second flexible fastening tab is defined a neck, wherein the first flexible fastening tab and the second flexible fastening tab retain with the through hole of the connection plate.

6. The tool holder as claimed in claim 1, wherein the fixing mount has a hanging aperture defined away from the connection plate.

7. The tool holder as claimed in claim 1, wherein the first side plate also has a first stop portion formed on a second end thereof, and the second side plate also has a second stop portion formed on a second end thereof.

8. The tool holder as claimed in claim 1, wherein the first fitting portion and the second fitting portion define the fitting zone in a square shape so as to fit a tool.

9. The tool holder as claimed in claim 1, wherein the first fitting portion has two first tilted faces defined on two edges of an outer rim thereof respectively, and the second fitting portion has two second tilted faces defined on two edges of an outer rim thereof respectively.
